(19) United States
(12) Patent Application Publication
(10) Pub. No.: US 2010/0225283 A1
(43) Pub. Date: Sep. 9, 2010

(54) FAST CHARGING ELECTRONIC SYSTEM

(75) Inventors: Chun-Hua HSIA, Taipei (TW); Ching-Shun WANG, Taipei (TW); Ming-Chung WANG, Taipei (TW)

Correspondence Address: LADAS & PARRY, 5670 WILSHIRE BOULEVARD, SUITE 2100, LOS ANGELES, CA, 90036-5679, US

(73) Assignee: ADVANCED CONNECTION TECHNOLOGY INC., Taipei (TW)

(21) Appl. No.: 12/399,373

(22) Filed: Mar. 6, 2009

(51) Int. Cl. H02J 7/00

(52) U.S. Cl. 320/167

(57) ABSTRACT

A fast charging electronic system includes an adapter having an interface module adapted to receive an input voltage from an external source, and an adapter port electrically connected to the interface module to output the input voltage. The fast charging electronic system further includes a wireless electronic device having a charging port removably and electrically connected to the adapter port of the adapter to receive the input voltage output therefrom, a charging module electrically connected to the charging port to receive the input voltage and convert the input voltage into a charge electrical energy, and a supercapacitor electrically connected to the charging module to receive the charge electrical energy therefrom for storage of an operating electrical energy, and outputting the operating electrical energy to enable operation of the wireless electronic device.

### BACKGROUND OF THE INVENTION

1. Field of the Invention

The invention relates to a fast charging electronic system, more particularly to a fast charging electronic system including a wireless device and a supercapacitor.

2. Description of the Related Art

One advantage of rechargeable batteries used in conventional wireless electronic devices is that they are more environmentally friendly than disposable batteries. Most wireless electronic devices are installed with at least one Nickel-Metal Hydride (Ni-MH) battery, Nickel-Cadmium (Ni—Cd) battery or lithium battery. Some, but not many, electronic devices are installed with at least one fuel cell, bio-battery, or supercapacitor. A supercapacitor includes electrodes made of active carbon, and electrolyte made of an organic material such as aqueous potassium hydroxide or propylene carbonate.

The Ni-MH battery, Ni—Cd battery and lithium battery are associated with a very time-consuming charging process, and therefore, are inconvenient when urgent use of an electronic device is required.

### SUMMARY OF THE INVENTION

Therefore, the object of the present invention is to provide a fast charging electronic system including a wireless device and a supercapacitor.

Accordingly, a fast charging electronic system of the present invention includes an adapter having an interface module adapted to receive an input voltage from an external source, and an adapter port electrically connected to the interface module to output the input voltage. The fast charging electronic system further includes a wireless electronic device having a charging port removably and electrically connected to the adapter port of the adapter to receive the input voltage output therefrom, a charging module electrically connected to the charging port to receive the input voltage and convert the input voltage into a charge electrical energy, and a supercapacitor electrically connected to the charging module to receive the charge electrical energy therefrom for storage of an operating electrical energy, and outputting the operating electrical energy to enable operation of the wireless electronic device.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of a preferred embodiment of a fast charging electronic system of the present invention, illustrating the fast charging electronic system in a state electrically connected to a computer;

FIG. 2 is a perspective view of a second preferred embodiment of the present invention, in which an adapter is configured as an adapter seat;

FIG. 3 is a schematic circuit block diagram of a wireless input device and a receiver of FIG. 1;

FIG. 4 is a circuit diagram of the wireless input device of the fast charging electronic system of FIG. 1;

FIG. 5 is a circuit diagram of the receiver of the fast charging electronic system of FIG. 1; and

FIG. 6 is a schematic circuit block diagram of a third preferred embodiment of the present invention.

### DETAILED DESCRIPTION OF THE PREFERRED EMBODIMENTS

Before the present invention is described in greater detail, it should be noted that like elements are denoted by the same reference numerals throughout the disclosure.

It is noted that a fast charging electronic system 100 of the present invention comprises a wireless electronic device and an adapter. For purposes of illustration, an example is given in which the wireless electronic device is a wireless input device 1 and the adapter is a receiver 2 in the following preferred embodiments. However, in addition to the disclosed embodiments, the combination of the wireless electronic device and the adapter may, in other embodiments, result in an electric shaver, an electric toothbrush, etc.

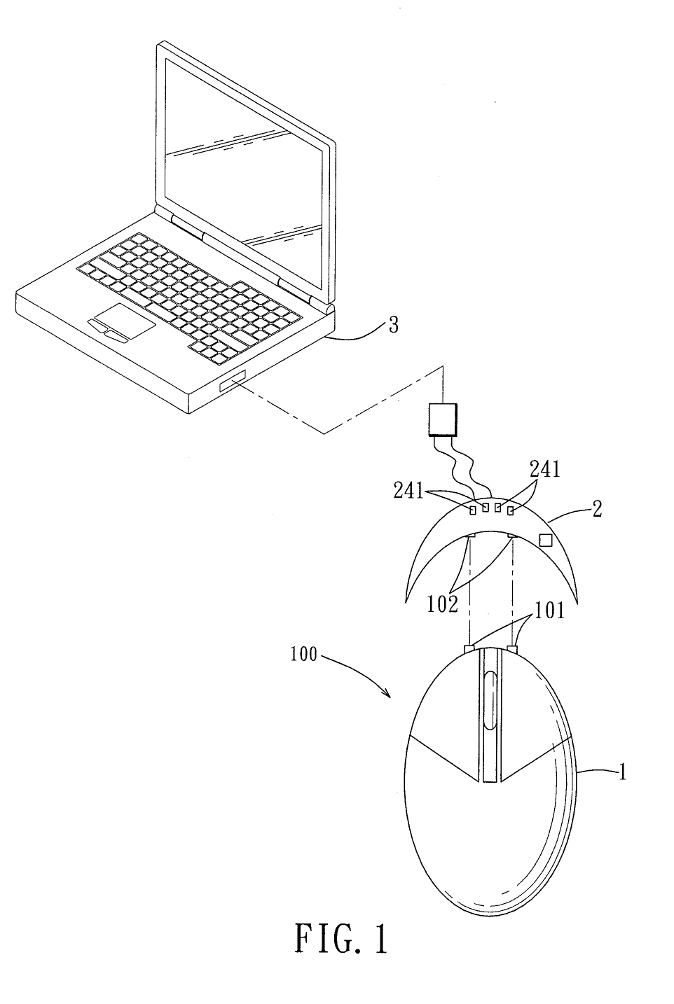

Referring to FIG. 1, the fast charging electronic system 100 of a first preferred embodiment according to the present invention comprises a wireless input device 1, and a receiver 2 adapted to be electrically connected to a computer 3.

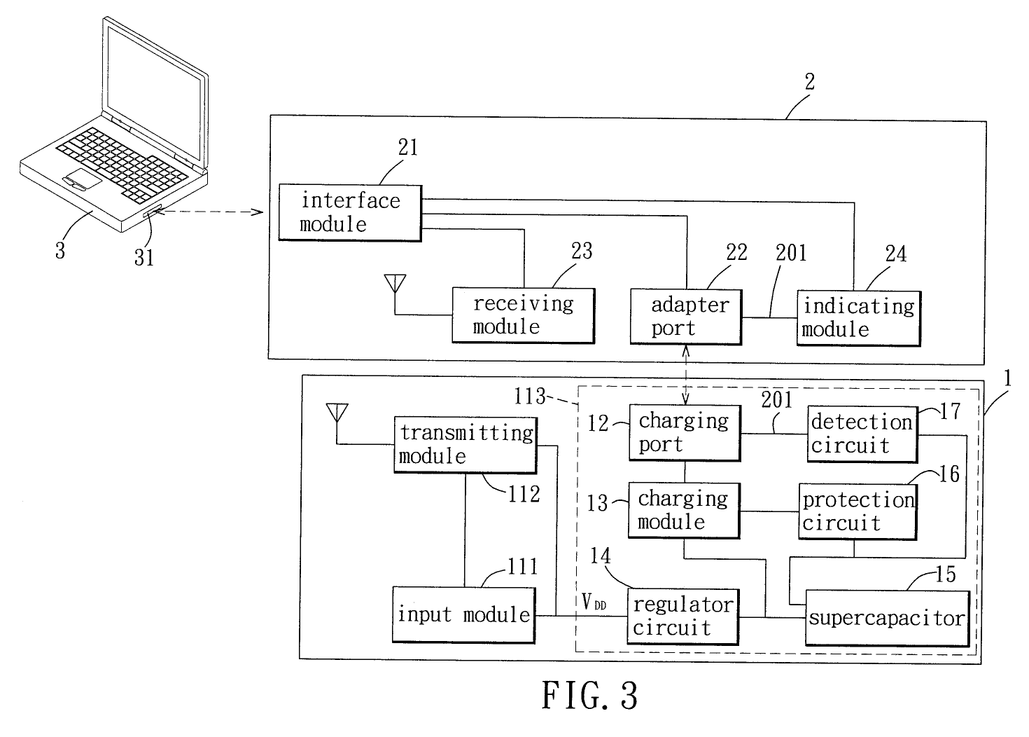

The wireless input device 1 is a wireless mouse including a set of first connection points 101 electrically connected to a set of second connection points 102 of the receiver 2. The receiver 2 is adapted to receive an input voltage V_{cc} (see FIG. 3) from the computer 3. A plurality of indicating lights 241 are disposed on the receiver 2 for indicating operating and charging states of the wireless input device 1.

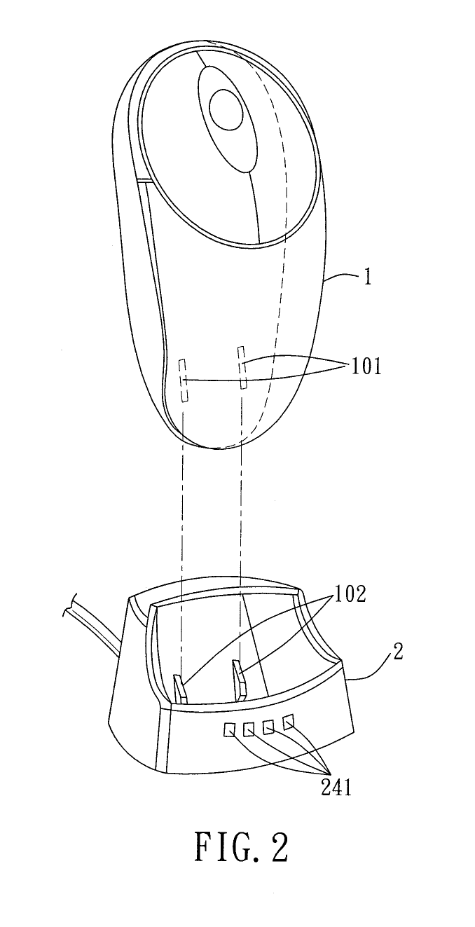

Referring to FIG. 2, in a second preferred embodiment of the present invention, the adapter 2 is configured as an adapter seat for holding the wireless input device 1.

Referring to FIGS. 1 and 3, in the first preferred embodiment, the wireless input device 1 has an input module 111, a transmitting module 112, and a power source circuit 113. The input module 111 is an optical sensor component for generating X-Y coordinate data as user input information in response to user movement of the wireless input device 1. The transmitting module 112 wirelessly transmits the X-Y coordinate data to the receiver 2.

Referring to FIG. 3, the receiver 2 has an interface module 21 adapted to receive the input voltage V_{CC} from the computer 3, and an adapter port 22 electrically connected to the interface module 21 to output the input voltage V_{CC}. The receiver 2 further has a receiving module 23 that receives the X-Y coordinate data transmitted by the transmitting module 112 of the wireless input device 1, and an indicating module 24 electrically connected to the adapter port 22 that indicates the operating and charging states of the wireless input device 1.

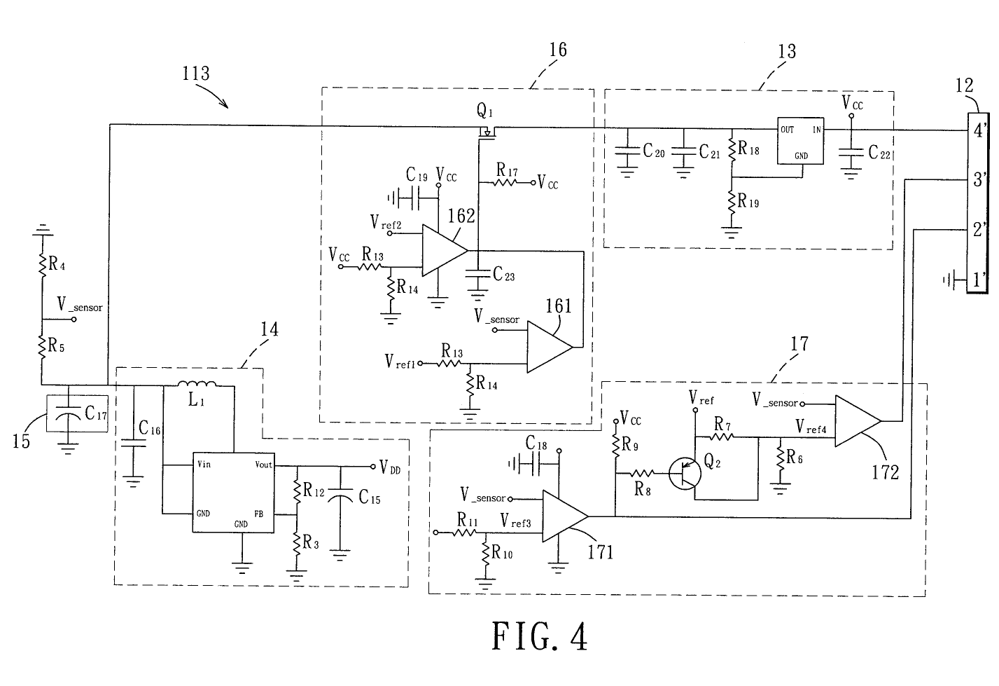

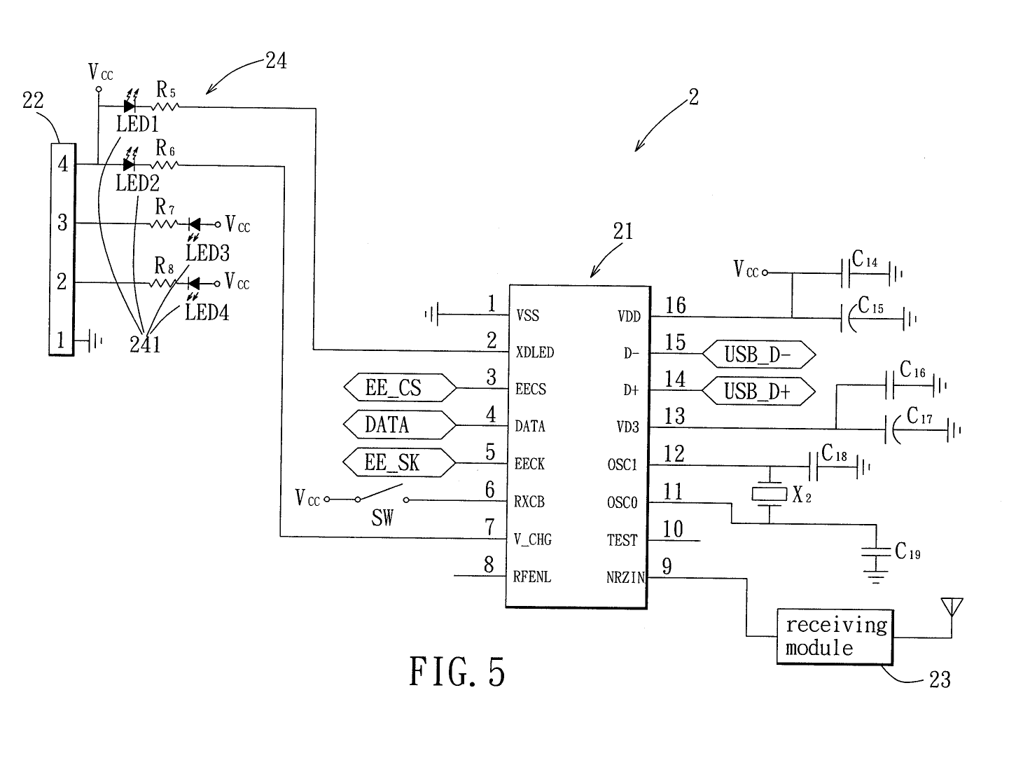

In the first preferred embodiment, the interface module 21 of the receiver 2 is adapted to relay the user input information wirelessly transmitted from the wireless input device 1 to the computer 3. The interface module 21 transmits the X-Y coordinate data received from the receiving module 23, and is adapted to connect to an interface module 31 of the computer 3 to receive the input voltage V_{CC} (5V) from the computer 3, i.e., a pin 4 of the adapter port 22 (shown in FIG. 5) receives the input voltage V_{CC}. Pins 1, 2, 3, 4 of the adapter port 22 are respectively connected to pins 1′, 2′, 3′, 4′ of the charging port 12 of the wireless input device 1 (shown in FIG. 4).

Referring to FIGS. 3 and 4, the power source circuit 113 of the wireless input device 1 includes a charging port 12, a charging module 13, a regulator circuit 14, a supercapacitor 15, a protection circuit 16, and a detection circuit 17.

The charging port 12 is removably and electrically connected to the adapter port 22 of the receiver 2 to receive the input voltage V_{CC} output therefrom. In the second preferred embodiment shown in FIG. 2, the charging port 12 is electrically connected to the adapter port 22 when the wireless input device 1 is received in the adapter 2. The charging module 13 is electrically connected to the charging port 12 to receive the input voltage V_{CC} and convert the input voltage V_{CC} into a charge electrical energy. The supercapacitor 15 is electrically connected to the charging module 13 to receive the charge electrical energy therefrom for storage of an operating electrical energy. The supercapacitor 15 outputs the operating electrical energy to enable operation of the wireless input device 1. The regulator circuit 14 is electrically connected to the supercapacitor 15 and regulates the operating electrical energy output by the supercapacitor 15.

Referring to FIG. 4, the specification of the supercapacitor 15 in the first preferred embodiment is 50F/2.7V. The supercapacitor 15 is fully charged in two minutes when an input voltage/current is 5V/500 mA. The operating electrical energy of the supercapacitor 15 output to the input module 111 and the transmitting module 112 is 3V and may be sustained for 1-4 hours.

The charging module 13 includes an adjustable regulator incorporated with capacitors C₂₀, C₂₁, C₂₂ and resistors R₁₈, R₁₉ to step the input voltage 5V down to 2.95V.

The protection circuit 16 is electrically connected to the charging module 13 and the supercapacitor 15. The protection circuit 16 has a first comparator 161, a second comparator 162, and a switch Q₁. A sensor voltage V_sensor is acquired from a voltage divided by resistors R4 and R5. The input voltage V_{CC} is acquired from the pin 4′ of the charging port 12.

The switch Q₁ is electrically connected to the first comparator 161 and the charging module 13. A power to the charging module 13 is controlled by the switch Q₁ depending on an output of the first comparator 161. The first comparator 161 receives input of the sensor voltage V_sensor of the supercapacitor 15 and a first reference voltage V_{ref1}. An output end of the first comparator 161 is coupled to the switch Q₁ and outputs a conducting signal when the sensor voltage V_sensor is lower than the first reference voltage V_{ref1}, and outputs a non-conducting signal when the sensor voltage V_sensor is one of equal to and higher than the first reference voltage V_{ref1}. For example, when the first reference voltage V_{ref1} is 2.72V and the sensor voltage V_sensor is higher than 2.72V, the output end of the first comparator 161 outputs a non-conducting signal such that the switch Q₁ is not turned on.

The second comparator 162 receives input of the input voltage V_{CC} and a second reference voltage V_{ref2}. An output end of the second comparator 162 is coupled to the switch Q₁ and outputs a conducting signal when the second reference voltage V_{ref2} is lower than the input voltage V_{CC}, and outputs a non-conducting signal when the second reference voltage V_{ref2} is one of equal to and higher than the input voltage V_{CC}. For example, when the second reference voltage V_{ref2} is 4V and the input voltage V_{CC} is lower than 4V, the output end of the second comparator 162 outputs a non-conducting signal such that the switch Q₁ is not turned on.

The protection circuit 16 disconnects supply of the charge electrical energy to the supercapacitor 15 from the charging module 13 when any abnormalities in the charge electrical energy are detected by the protection circuit 16.

Referring to FIG. 3, the regulator circuit 14 is a DC-DC transformer that boosts the operating electrical energy supplied by the supercapacitor 15 to obtain an input voltage V_{DD} for operation of the input module 111 and the transmitting module 112. In the first preferred embodiment, the regulator circuit 14 boosts 2.95V to 3V.

The detection circuit 17 is electrically connected to the supercapacitor 15 and detects a charging state of the supercapacitor 15. The detection circuit 17 outputs a detection signal 201 to the indicating module 24 through the charging port 12 and the adapter port 22. The indicating module 24 generates a charge indicating signal according to the detection signal 201 received from the detection circuit 17 when the supercapacitor 15 is being charged by the input voltage V_{CC}.

Referring to FIG. 4, the detection circuit 17 has a third comparator 171 and a fourth comparator 172. The indicating module 24 generates one of a fully charged indicating signal and a fully discharged indicating signal according to the detection signal 201 received from the detection circuit 17 when the supercapacitor 15 is one of fully charged and fully discharged, respectively. The third comparator 171 compares the sensor voltage V_{—sensor} and a third reference voltage V_{ref3} and outputs a fully charged indicating signal to the detection signal 201 when the sensor voltage V_{—sensor} is higher than the third reference voltage V_{ref3}. For example, when the third reference voltage V_{ref3} is 2.62V, the third comparator 171 outputs a fully charged signal to the indicating module 24 through the charging port 12 and the adapter port 22.

The fourth comparator 172 compares the sensor voltage V_{—sensor} and a fourth reference voltage V_{ref4} and outputs a charging signal to the detection signal 201 when the sensor voltage V_{—sensor} is higher than the fourth reference voltage V_{ref4}. For example, when the fourth reference voltage V_{ref4} is 2.3V, the fourth comparator 172 outputs a charging signal to the indicating module 24 through the charging port 12 and the adapter port 22.

Referring to FIG. 5, the interface module 21 is a universal series bus (USB) interface module. Pins 3, 4, 5, 6, 14, and 15 of the interface module 21 are electrically connected to the computer 3 (shown in FIG. 1) to transmit EE_CS, DATA, EE_SK, V_{CC}, USB_D−, and USB_D+ signals. Pin 9 of the interface module 21 is electrically connected to the receiving module 23 which receives the X-Y coordinate data transmitted by the wireless input device 1. Pins 2 and 7 of the interface module 21 are electrically connected to the indicating module 24 and the adapter port 22, respectively.

The indicating module 24 has four light emitting diodes (LEDs) LED1, LED2, LED3, and LED4, which are the four indicating lights 241 shown in FIG. 1. Pins 2 and 3 of the adapter port 22 are connected to LED3 and LED4, respectively, to show whether the supercapacitor 15 is charging or fully charged. LED1 and LED2 are coupled in parallel between pin 4 of the adapter port 22 and the interface module 21 to show whether the X-Y coordinate data is transmitting or the operating electrical energy of the supercapacitor 15 is fully discharged.

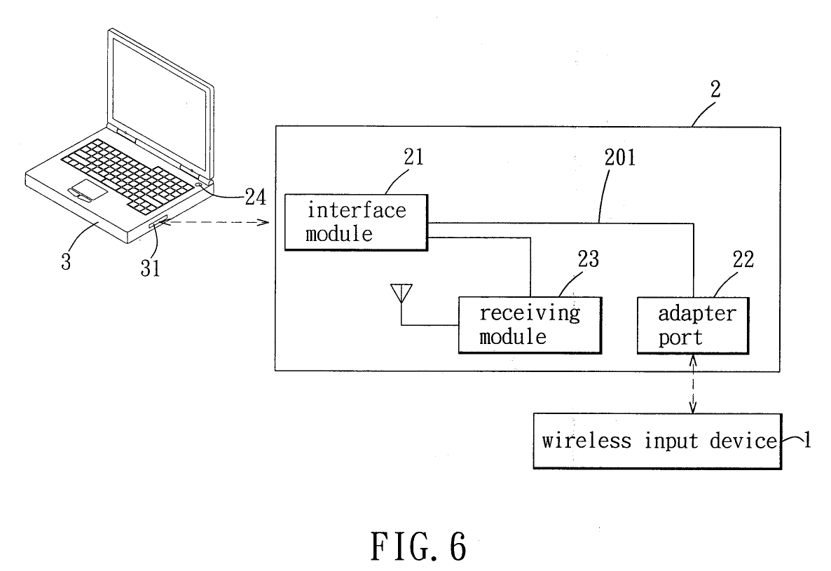

As shown in FIG. 6, a third preferred embodiment of the invention has a structure similar to that of the first embodiment. However, the main difference between this embodiment and the first embodiment resides in the configuration of the indicating module 24, which is adapted to be mounted on the computer 3 in this embodiment. The third preferred embodiment has the same advantages as those of the first preferred embodiment.

Compared to conventional systems that include rechargeable or disposable batteries, the advantages of the fast charging electronic system according to the present invention are as outlined in the following. The supercapacitor 15 can replace present rechargeable batteries and disposable batteries. Since the supercapacitor 15 can be charged in a very short time, convenience is provided to users of the fast charging electronic system of the present invention. The indicating lights 241 indicating the charging and operating states of wireless input device 1 are mounted on the receiver 2 (or the computer 3 in the case of the third preferred embodiment), thus reducing power consumption of the wireless input device 1.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A fast charging electronic system comprising:
an adapter including
an interface module adapted to receive an input voltage from an external source, and
an adapter port electrically connected to said interface module to output the input voltage; and a wireless electronic device including
a charging port removably and electrically connected to said adapter port of said adapter to receive the input voltage output therefrom,
a charging module electrically connected to said charging port to receive said input voltage and convert the input voltage into a charge electrical energy, and
a supercapacitor electrically connected to said charging module to receive the charge electrical energy therefrom for storage of an operating electrical energy, said supercapacitor outputting the operating electrical energy to enable operation of said wireless electronic device.

2. The fast charging electronic system as claimed in claim 1, wherein said wireless electronic device further includes a protection circuit electrically connected to said charging module and said supercapacitor, said protection circuit disconnecting supply of the charge electrical energy to said supercapacitor from said charging module when any abnormalities in the charge electrical energy are detected by said protection circuit.

3. The fast charging electronic system as claimed in claim 2, wherein said protection circuit includes a first comparator and a switch, said switch being electrically connected to said first comparator and said charging module, a power to said charging module being controlled by said switch depending on an output of said first comparator, said first comparator receiving input of a sensor voltage of said supercapacitor and a first reference voltage, an output end of said first comparator being coupled to said switch, said output end outputting a conducting signal when the sensor voltage is lower than the first reference voltage, and outputting a non-conducting signal when the sensor voltage is one of equal to and higher than the first reference voltage.

4. The fast charging electronic system as claimed in claim 2, wherein said protection circuit includes a second comparator and a switch, said switch being electrically connected to said second comparator and said charging module, a power to said charging module being controlled by said switch depending on an output of said second comparator, said second comparator receiving input of the input voltage and a second reference voltage, an output end of said second comparator being coupled to said switch, said output end outputting a conducting signal when the second reference voltage is lower than the input voltage, and outputting a non-conducting signal when the second reference voltage is one of equal to and higher than the input voltage.

5. The fast charging electronic system as claimed in claim 1, wherein said wireless electronic device further includes a detection circuit electrically connected to said supercapacitor, said detection circuit detecting a charging state of said supercapacitor and generating a corresponding detection signal.

6. The fast charging electronic system as claimed in claim 5, wherein said detection circuit of said wireless electronic device is electrically connected to said charging port, said adapter further including an indicating module electrically connected to said adapter port, said detection circuit outputting the detection signal to said indicating module through said charging port and said adapter port, said indicating module generating a charge indicating signal according to the detection signal received from said detection circuit when said supercapacitor is being charged by the input voltage.

7. The fast charging electronic system as claimed in claim 5, wherein said detection circuit of said wireless electronic device is electrically connected to said charging port, said adapter further including an indicating module electrically connected to said adapter port, said detection circuit outputting the detection signal to said indicating module through said charging port and said adapter port, said indicating module generating one of a fully charged indicating signal and a fully discharged indicating signal according to the detection signal received from said detection circuit when said supercapacitor is one of fully charged and fully discharged, respectively.

8. The fast charging electronic system as claimed in claim 1, wherein said wireless electronic device further includes a regulator circuit electrically connected to said supercapacitor, said regulator circuit regulating the operating electrical energy output by said supercapacitor.

9. A fast charging electronic system comprising:
a receiver adapted to be electrically connected to a computer, said receiver including
an interface module adapted to receive an input voltage from the computer, and
an adapter port electrically connected to said interface module to output the input voltage; and
a wireless input device wirelessly transmitting user input information to said receiver, said wireless input device including
a charging port removably and electrically connected to said adapter port of said receiver to receive the input voltage output therefrom,
a charging module electrically connected to said charging port to receive the input voltage and convert the input voltage into a charge electrical energy, and
a supercapacitor electrically connected to said charging module to receive the charge electrical energy therefrom for storage of an operating electrical energy, said supercapacitor outputting the operating electrical energy to enable operation of said wireless input device;
wherein said interface module of said receiver is adapted to relay the user input information wirelessly transmitted from said wireless input device to the computer.

10. The fast charging electronic system as claimed in claim 9, wherein said wireless input device further includes a protection circuit electrically connected to said charging module and said supercapacitor, said protection circuit disconnecting supply of the charge electrical energy to said supercapacitor from said charging module when any abnormalities in the charge electrical energy are detected by said protection circuit.

11. The fast charging electronic system as claimed in claim 10, wherein said protection circuit includes a first comparator and a switch, said switch being electrically connected to said first comparator and said charging module, a power to said charging module being controlled by said switch depending on an output of said first comparator, said first comparator receiving input of a sensor voltage of said supercapacitor and a first reference voltage, an output end of said first comparator being coupled to said switch, said output end outputting a conducting signal when the sensor voltage is lower than said first reference voltage, and outputting a non-conducting signal when the sensor voltage is one of equal to and higher than the first reference voltage.

12. The fast charging electronic system as claimed in claim 10, wherein said protection circuit includes a second comparator and a switch, said switch being electrically connected to said second comparator and said charging module, a power to said charging module being controlled by said switch depending on an output of said second comparator, said second comparator receiving input of the input voltage and a second reference voltage, an output end of said second comparator being coupled to said switch, said output end outputting an conducting signal when said second reference voltage is lower than said input voltage, and outputting a non-conducting signal when the second reference voltage is one of equal to and higher than the input voltage.

13. The fast charging electronic system as claimed in claim 9, wherein said wireless input device further includes a detection circuit electrically connected to said supercapacitor, said detection circuit detecting a charging state of said supercapacitor and generating a corresponding detection signal.

14. The fast charging electronic system as claimed in claim 13, wherein said detection circuit of said wireless input device is electrically connected to said charging port, said receiver further including an indicating module electrically connected to said adapter port, said detection circuit outputting the detection signal to said indicating module through said charging port and said adapter port, said indicating module generating a charge indicating signal according to the detection signal received from said detection circuit when said supercapacitor is being charged by the input voltage.

15. The fast charging electronic system as claimed in claim 13, further comprising an indicating module adapted to be mounted on the computer, said detection circuit being electrically connected to said charging port, said detecting circuit outputting the detection signal to said indicating module through said charging port, said adapter port, and said interface module, said indicating module generating a charge indicating signal according to the detection signal received from said detection circuit when said supercapacitor is being charged by the input voltage.

16. The fast charging electronic system as claimed in claim 9, wherein said wireless input device further includes a regulator circuit electrically connected to said supercapacitor, said regulator circuit regulating the operating electrical energy output by said supercapacitor.

17. The fast charging electronic system as claimed in claim 9, wherein said wireless input device is a wireless mouse.

18. The fast charging electronic system as claimed in claim 17, wherein said wireless input device further includes an input module for generating X-Y coordinate data as the user input information in response to user movement of said wireless input device, and a transmitting module for wirelessly transmitting the X-Y coordinate data to said receiver.

19. The fast charging electronic system as claimed in claim 17, wherein said receiver is configured as a seat for holding said wireless input device, said charging port of said wireless input device being electrically connected to said adapter port of said receiver when said wireless input device is held in said receiver.

20. The fast charging electronic system as claimed in claim 9, wherein said wireless input device is a wireless keyboard.
